(19) United States
(12) Patent Application Publication
(10) Pub. No.: US 2017/0026385 A1
(43) Pub. Date: Jan. 26, 2017

(54) METHOD AND SYSTEM FOR PROXIMITY-BASED ACCESS CONTROL

(71) Applicant: Satellite Technologies LLC, Minneapolis, MN (US)

(72) Inventors: Amir Masoud Zarkesh, Saratoga, CA (US); Daniel Fishkov, San Jose, CA (US); Ty Lindteigen, Tempe, AZ (US); Paul T. Kitaj, Tempe, AZ (US); Dipen T. Patel, Tempe, AZ (US)

(73) Assignee: Satellite Technologies LLC, Minneapolis, MN (US)

(21) Appl. No.: 15/217,171

(22) Filed: Jul. 22, 2016

Related U.S. Application Data
(60) Provisional application No. 62/196,271, filed on Jul. 23, 2015.

(51) Int. Cl. H04L 29/06; H04W 4/00; H04W 12/08; H04L 29/08

(52) U.S. Cl. CPC H04L 63/107; H04L 67/10; H04W 4/008; H04W 12/08

(57) ABSTRACT

A system, method and computer program product for proximity-based access control, including a physical token device having a programmable computing device, a memory storage device, and a wireless radio device having a limited range; and a user device that couples to the physical token device over one of: a wireless interface to the wireless radio device integrated into the physical token, and a physical interface to the physical token with electrical connectivity between the physical token and the user device. The programmable computing device is configured to only allow the user device to access the memory storage device over the wireless or physical interface when the physical token device is either within the limited range of the wireless radio device, or physically attached such that electrical connection is possible, respectively.

### CROSS REFERENCE TO RELATED APPLICATIONS

The present invention claims priority to U.S. Provisional Patent Application Ser. No. 62/196,271 of Zarkesh et al., entitled “METHOD AND SYSTEM FOR PROXIMITY-BASED ACCESS CONTROL,” filed on Jul. 23, 2015, the entire disclosure of which is hereby incorporated by reference herein.

### BACKGROUND OF THE INVENTION

Field of the Invention

The present invention generally relates to systems and methods for access control, and the like, more particularly to systems and methods for proximity-based access control based on a physical token, and the like.

Discussion of the Background

In recent years, systems and methods for access control, and the like, have been developed. However, such systems lack robustness and features sets across multiple platforms with respect to proximity-based access control, and the like.

### SUMMARY OF THE INVENTION

Therefore, there is a need for methods and systems for access control, and the like. Accordingly, the above and other needs are addressed by the illustrative embodiments of the present invention, which provide a novel method and system for proximity-based access control based on a physical token, and the like.

Accordingly, in an illustrative aspect, there is provided a system, method and computer program product for proximity-based access control, including a physical token device having a programmable computing device, a memory storage device, and a wireless radio device having a limited range; and a user device that couples to the physical token device over one of: a wireless interface to the wireless radio device integrated into the physical token, and a physical interface to the physical token with electrical connectivity between the physical token and the user device. The programmable computing device is configured to only allow the user device to access the memory storage device over the wireless or physical interface when the physical token device is either within the limited range of the wireless radio device, or physically attached such that electrical connection is possible, respectively.

The physical token device is one of a Fob device, a keyfob device, a wristband device, a ring device, and a credit card device.

The user device is one of an Android device, an iPhone device, a tablet device, a smartphone device, a workstation, a PC, a laptop, or generally any device or adapter which provides a frame or sleeve for physical including mechanical or electro-permanent magnetic capture of the physical token device.

The wireless radio device is one of a Bluetooth radio device, a Wi-Fi radio device, and a Near Field Communication (NFC) radio device, and the wireless interface is one of a Bluetooth wireless interface, a Wi-Fi wireless interface, and an NFC wireless interface.

The physical token device includes a token interface application configured to interface the physical token device over a cloud-based network with a Security Framework Provider (SFP).

The physical token device includes a USB port, or other physical connection providing electrical connectivity, for charging the physical token device from the user device, and providing a secure connection to the Security Framework Provider (SFP) over the cloud-based network via the user device coupled to the physical token device via the USB port, as well as a secure connection for sensitive operations, including keying, and provisioning operations.

Still other aspects, features, and advantages of the present invention are readily apparent from the following detailed description, simply by illustrating a number of illustrative embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 illustrates customer and organization interaction, and the like;

FIG. 2 illustrates configurations for unlock, and the like;

FIG. 3 illustrates Device Preparation, and the like;

FIG. 4 illustrates a Top Level State Transition Diagram, and the like;

FIG. 5 illustrates Device Keying, and the like;

FIG. 6 illustrates Device Provisioning with a Management Service, and the like.

FIG. 7 illustrates Device Association, and the like;

FIG. 8 illustrates Device Unlocking, and the like; and

FIG. 9 illustrates a Data Flow Diagram for Transfer Operations, and the like

### DETAILED DESCRIPTION OF THE PREFERRED EMBODIMENTS

The present invention includes recognition that the Concept of operations (CONOP) presented here is built around the concept of a physical token that enables a proximity-based access control model for sensitive user data stored on user devices (e.g., tablets, smartphones, workstations), or in a cloud folder, and the like. The present disclosure describes the concept of operation for a secure privacy system and method based on, for example, processing capability and storage capabilities, and the like, embedded in a device with a form factor analogous to a key fob, and the like. Such device is called a Proximity Access Control (PAC) Token, and, for example, includes a wireless, such as Bluetooth, and the like, radio with limited range so that eavesdropping is difficult and easy to detect. The Proximity Access Control Token can provide a micro USB port, which can be used for (1) charging as well as (2) a confidential connection for sensitive operations, such as keying, and the like. For such option, the Proximity Access Control Token can be configured as a host USB, and the like. The Proximity Access Control Token can also provide other ports allowing direct electrical connection between the Proximity Access Control Token and a user device, or direct electrical connection between the Proximity Access Control Token and an interface device, such as a sleeve or similar adapter, which interface device connects to the user device. A provided commercial off the shelf Host Platform, such as an Android or iPhone platform, and the like, that supports a Bluetooth interface can be pre-loaded with PAC Token Interface Applications. PAC Token Interface Applications are built to interface with the Proximity Access Control Token, as well as a cloud-based network, and the like, provided by a Security Framework Provider (SFP).

The following nomenclature, for example, is adopted in the present disclosure: A privacy device is a “Proximity Access Control Token” or “PAC Token”. A “User Device” is a commercial off-the-shelf (COTS) platform(s) of a user, and which houses PAC Token Interface Applications, and associates with a Proximity Access Control Token; A “Backup User Device” is a COTS platform(s) of a user and which stores User Data; A “Cloud User Device” is a network platform(s) of a user and which stores User Data; A “Security Framework Provider Embedded App” is a security application running on the Proximity Access Control Token that provides security services (e.g., confidentiality and integrity); “PAC Token Interface Apps” are applications that run on the User Device and interface with the Proximity Access Control Token for non-volatile storage. The key used by one Proximity Access Control Token to store Black Data such that another Proximity Access Control Token can decrypt the Black Data is referred to as the “Transfer Key”; Data encrypted with a Transfer Key is referred to as “Black Transfer Data”; An encrypted Transfer Key is referred to as a “Black Transfer Key”; A password that enables decryption of a Black Transfer Key is referred to as a “Transfer Password”; A split value that enables decryption of a Black Transfer Key is referred to as a “Transfer Split”.

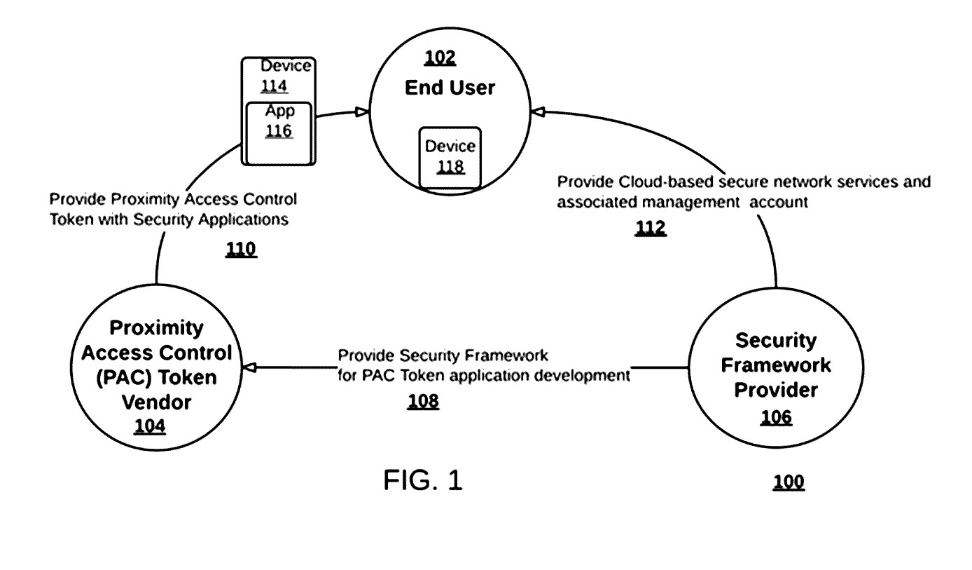

Referring now to the drawings, wherein like reference numerals designate identical or corresponding parts throughout the several views, and more particularly to FIG. 1 thereof, there is shown an illustrative customer and organization interaction, and the like. In FIG. 1, the system can include an end user 102, a device provider 104 (e.g., referred to herein as the PAC Token Vendor), and Security Framework provider 106. The security framework provider 106 provides a framework for application development to the device provider 104 at step 108. The device provider 104 provides a device 114 (e.g., referred to herein as a Proximity Access Control Token) including an application 116 based on the application development framework to the end user 102 at step 110. The security framework provider 106 also provides access and a management services account for a cloud-based secure network run by the security framework provider at step 112.

Primary security services can include Secure Data Storage and Secure Transfer. The device 114 in tandem with an associated User Device 118 enable the user 102 to securely store application data on the device 114 (e.g., configured as Secure Data Storage), as well as transfer data securely off of the device 114 for later access by that device 114 or any other device 114 whose user has the Transfer Password (e.g., configured as Secure Transfer).

An Access Control Model Overview includes a password established for the device 114 as part of the process of keying. The password is used, cryptographically, to unlock the device 114 keyset. Access control models are proposed for unlocking the device 114 security services, for example, as follows.

In a Proximity Only Model, once the password has been entered successfully then as long as the device 114 has power it can provide security services to the User Device 118 that it has associated with based only on the device 114 being in proximity to the associated User Device 118. Because security critical key variables in the device 114 (e.g., the Private Key and Keys associated with secure storage) are restricted to volatile (RAM) storage only, if power is lost, the password can be re-entered, but once it has been entered, the proximity model enables security services as soon as proximity occurs.

In a Proximity Plus Password (Proximity+PW), a more conservative access control model, the device 114 provides security services to the User Device 118 it has associated with only if the device 114 is in proximity to the User Device 118 and the password is correctly entered.

PAC Token Unlock Configuration allows the device 114 to support configurations for unlock that range from requiring access to the SFP Network to unlock to unlocking regardless of SFP Network access.

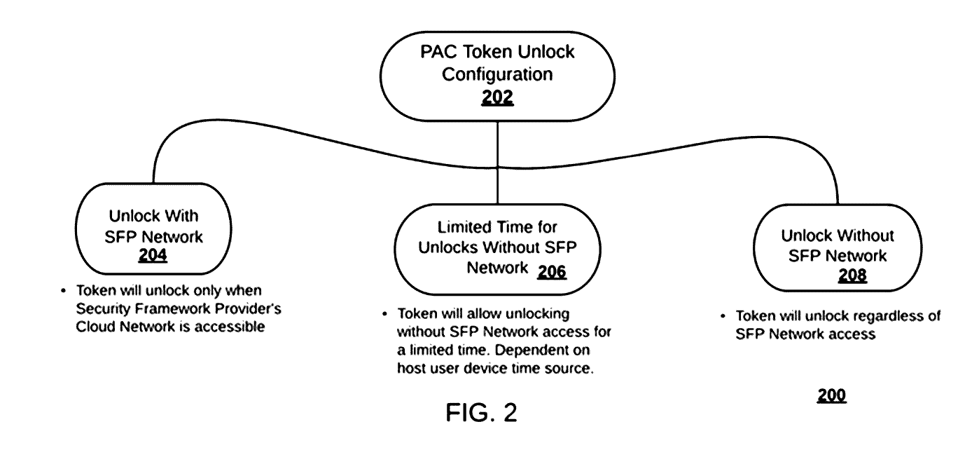

FIG. 2 illustrates configurations 202 for unlock, and the like. In FIG. 2, configuring to “Unlock With SFP Network” at step 204 employs the device 114 gaining SFP Network access prior to allowing access to services or data. Advantageously, this provides assurance that revocation information (e.g., potentially including a revocation targeted at the device 114 itself) is received. Configuring to “Limited Time for Unlocks Without SFP Network” at step 206 allows a user-specified limited time window where SFP Network access is not required to unlock. For example, this is advantageous for a traveler who knows that Internet access may be limited for a time (e.g., long flight without internet access), so allowing unlock without SFP Network Access in that time window will not introduce any significant security weakness. Configuring to “Unlock Without SFP Network” at step 208 is the least secure configuration, as a stolen device 114 can be used to extract information, given that the user cannot guarantee that a revocation message will reach the stolen device 114.

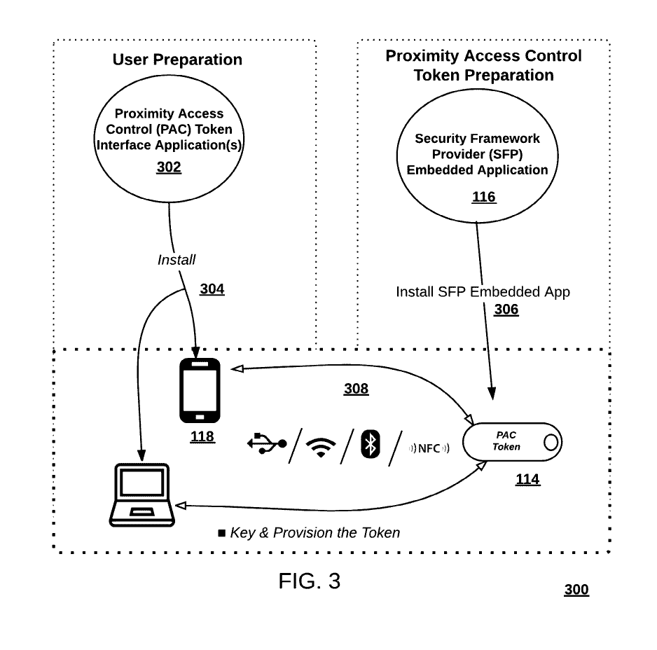

FIG. 3 illustrates Device Preparation, and the like. In FIG. 3, applications 302 (e.g., referred to herein as PAC Token Interface Apps) are installed (e.g., over the Internet) at step 304 on commercial off-the-shelf (COTS) User Devices 118. Such configured User Devices 118 can then interface with the device 114 loaded (e.g., over the Internet) at step 306 with the application 116 (e.g., the Security Framework Provider Embedded Application) to provide security functions. Communications between the device 114 and the User Devices 118 can be over any suitable form of wireless communication links 308 (e.g., Bluetooth, Bluetooth Low Energy, WiFi, WLAN), and the like.

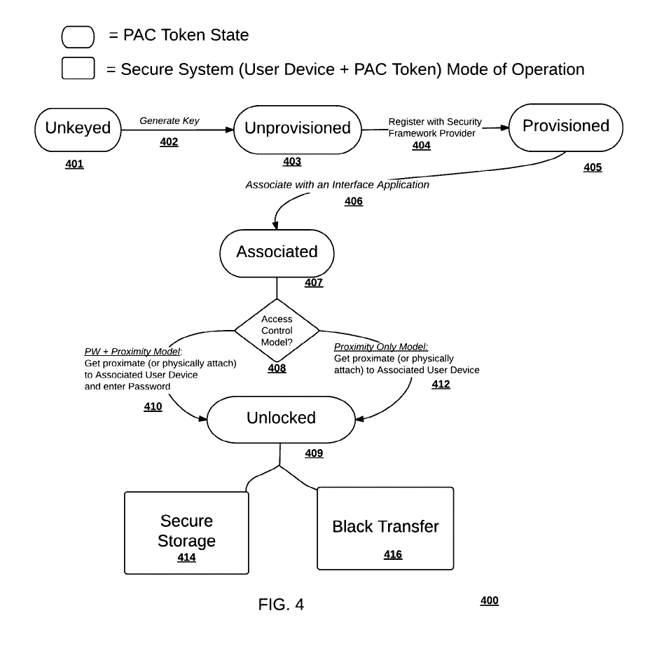

FIG. 4 illustrates a Top Level State Transition Diagram, and the like. In FIG. 4, the device 114 (e.g., referred to herein as a Proximity Access Control Token) can be keyed from an unkeyed state 401 at step 402, provisioned from an unprovisioned state 403 to a provisioned state 405 at step 404, and associated at step 406 with the User Device 118 to reach an associated state 407. The device 114 then can be unlocked by the User Device 118 via access control model determination step 408, followed by access control step 410 or 412 to reach an unlocked state 409 before the device 114, for example, can provide secure storage at step 414, and black transfer security services at step 416, and the like.

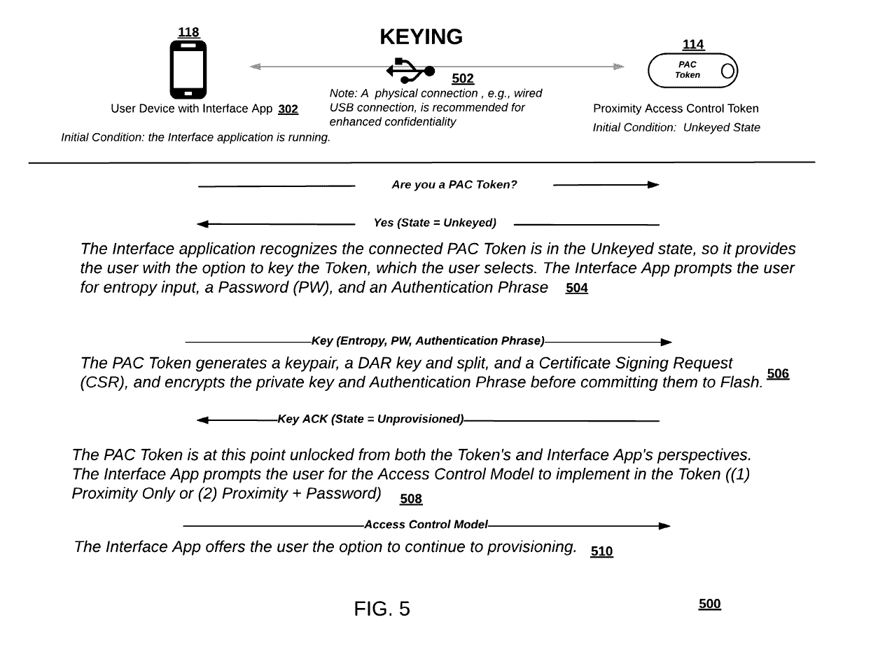

The following describes various Concept of Operation (ConOp) Scenarios. For example, FIG. 5 illustrates Device Keying, and the like. In FIG. 5, the user device 118 running the application 302 (e.g., referred to as the Interface App) communicates at step 502 (e.g., over a wired USB connection for enhanced confidentiality) with the device 114 that is in the unkeyed state 401. The described interactions in steps 504-510 between the application 302 (e.g., referred to as Keying) and the device 114 result in keying the device 114.

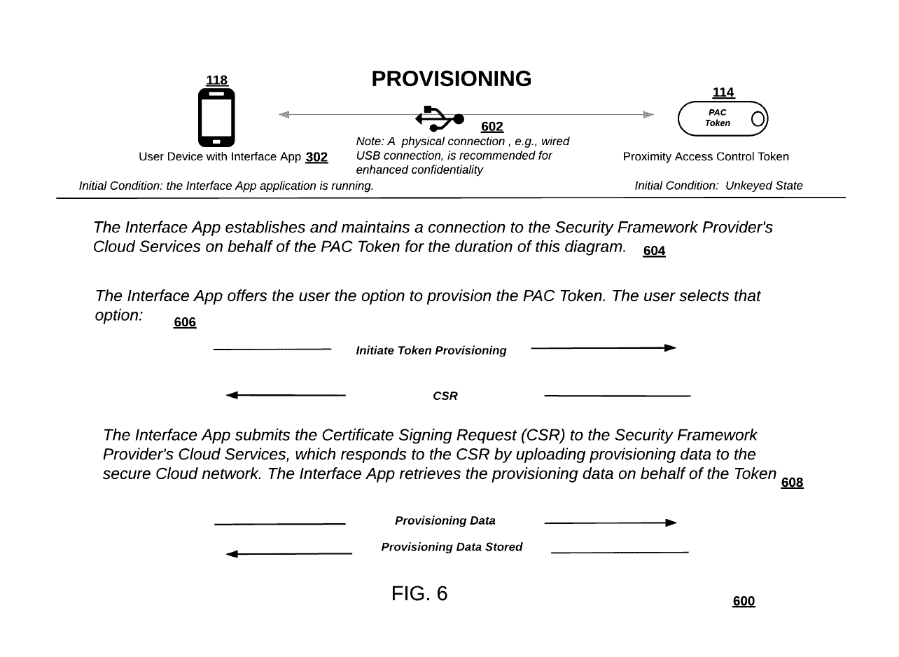

FIG. 6 illustrates Device Provisioning (e.g., the device 114) with a Management Service (e.g., Security Framework Provider Service), and the like. In FIG. 6, the user device 118 running the application 302 (e.g., referred to as the Interface App) communicates at step 602 (e.g., over a wired USB connection for enhanced confidentiality) with the device 114 that is in the unprovisioned state 403. The described interactions in steps 604-608 between the application 302 (e.g., referred to as Provisioning) and the device 114 result in the device 114 in the provisioned state 405.

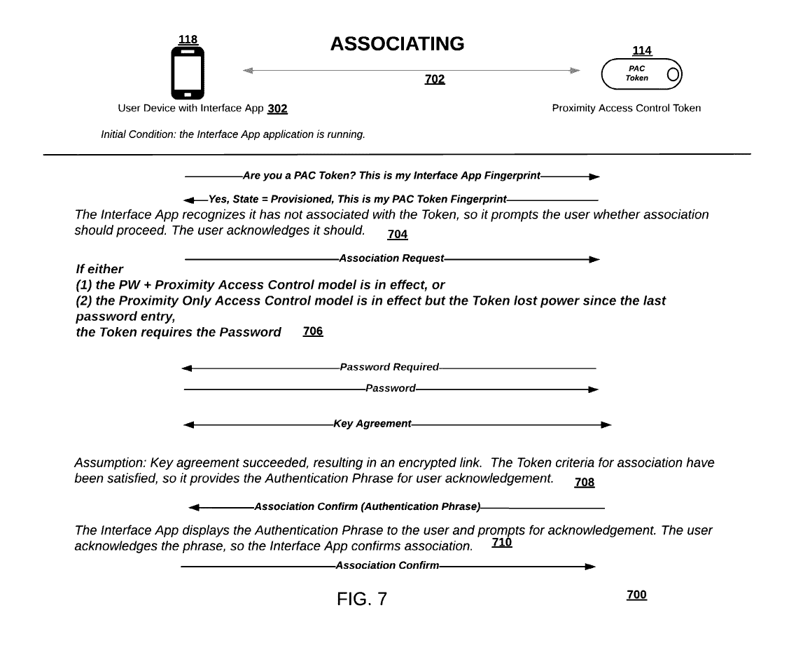

FIG. 7 illustrates Device Association, and the like. In FIG. 7, the user device 118 running the application 302 (e.g., referred to as the Interface App) communicates at step 702 (e.g., over a wireless or wired connection, where a wired connection may provide enhanced confidentiality) with the device 114 that is in the unassociated state. The described interaction in steps 704-710 between the application 302 (e.g., referred to as the Interface App) and the device 114 result in the device 114 in the associated state 407.

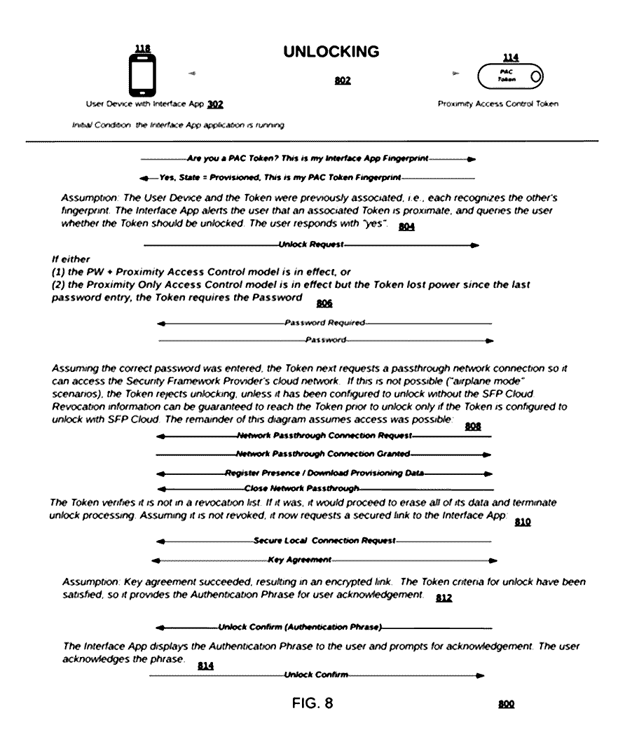

FIG. 8 illustrates Device Unlocking, and the like. In FIG. 8, the user device 118 running the application 302 (e.g., referred to as the Interface App) communicates at step 802 (e.g., over a wireless or wired connection, where a wired connection may provide enhanced confidentiality) with the device 114 that is in the locked state. The described interaction in steps 804-814 between the application 302 (e.g., referred to as the Interface App) and the device 114 result in the device 114 in the unlocked state 409. In an unlocked state, the device 114 can not only engage in exchanging sensitive data with the User Device 118, but device 114 can also serve as storage for information needed to access other systems' sensitive information. For example, a private key can be stored in device 114 which private key is cryptographically coupled to a public key stored on the user device 118. Only when device 114 is unlocked can the private key and public key be made accessible to applications that need the complete key pair to be able to access other security services, e.g., accessing other data stores, including those off-device (e.g., in a cloud storage server). The device 114 is thus capable of serving as a hardware token enabling single sign-on for a variety of systems, eliminating the need to memorize passwords for a variety of systems, but instead once unlocked making certificate-based access control possible while maintaining physical separation of the constituent parts of a keypair. When coupled with a configuration to “Unlock With SFP Network” (see step 204 of FIG. 2), selective revocation action can be realized through guaranteed contact with the SFP Network, which can issue fine grained revocations, e.g., targeting only one private key stored in device 114.

Installing of applications (e.g., referred to as Interface Apps) includes the applications, for example, being customized for each User Device 118 environment (e.g., 0/S), and the like. For example, Bluetooth Pairing between the device 114 and the User Device 118 can employ the described secure association that then rides on top of the basic Bluetooth connection. The securing of the interface between an application (e.g., referred to as an Interface App) and the device 114 includes establishing a link between the User Device 118 and the device 114 that is secured, for example, via certificates, and the like. Standard wireless security (e.g., Bluetooth, WiFi security), and the like, can be employed but advantageously need not be relied upon.

Red Data Exchange between an application (e.g., referred to as an Interface App) and the device 114 can be enabled, as well as providing an Interface Protocol configured to exchange data between multiple applications (e.g., referred to as Interface Apps) on the User Device 118 and a single device 114. An application (e.g., referred to as an Interface App) can also import Red Data from other applications.

In addition, Black Data can be copied to a Backup User Device 118, wherein the device 114 copies its ciphertext to the backup user device 118. For example, no special keying apart from that integrated into the device 114 for the purposes of its own Data At Rest (DAR). Black Data also can be moved to the Backup User Device 118, for example, for freeing up storage space on the device 114, while allowing the backed up data to be later read back in and be used. In this case, the device 114 can store XTS index information along with the Black Data. Black Data also can be transferred to the Backup User Device 118 in a similar manner.

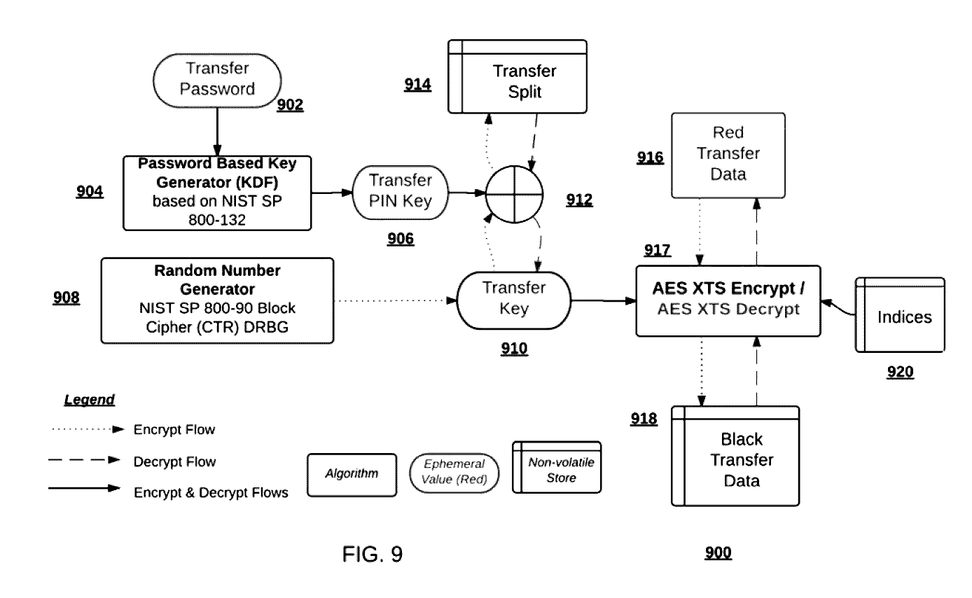

For example, FIG. 9 illustrates a Data Flow Diagram for Transfer Operations, and the like. In FIG. 9, a transfer password generated at step 902 is sent to a password based key generator at step 904, and which generates a transfer PIN key at step 906. A random number generator at step 908 can generate a transfer key at step 910, which is combined at step 912 to produce a Transfer Split at Step 914. Step 912 illustrates both the generation of the Transfer Split at Step 914 as well as the later use of the Transfer Split at Step 914 for re-generation of the Transfer Key at Step 910. For recovery of Transfer data, Step 912 involves interaction between the transfer split at step 914 and the transfer PIN key from step 906, reproducing the transfer key (originally generated by the Random Number Generator at Step 908) at step 910. The transfer key from step 910 is then used for encryption and decryption at step 917 for effectuating a red data transfer at step 916 and a black data transfer at step 918 based on indices 920. The processing of FIG. 9 is employed in order to store ciphertext data, for example, such that any device 114, along with a user that knows the Transfer Password from step 902, can be able to decrypt and use the Transfer Data. The Black Transfer Data can be moved to a Backup User Device 118 using the above described processing but with copy and then delete local. Accordingly, decrypting of the Black Transfer Data is enabled based the Data Flow Diagram for Transfer Operations of FIG. 9.

Patching (e.g., Software Updating) of the device 114 can employ software update authentication leveraging software signatures, and the like.

A Support for Multiple personas feature can be configured, for example, so that different persona data can be stored encrypted with unique keys tied to passwords, or with multiple passwords employed but only a single keyset for Data At Rest encryption/decryption being in effect, and the like.

The Decommissioning of the device 114 can be realized whereby revoking a PAC Token deletes its Keystore, permanently removing access to Secure Storage. Deactivation, which eliminates PIN based decryption of Secure Storage contents, but allows for later reactivation over the air can be provided via the management account provided by the Security Framework Provider.

The following table summarizes various Vulnerability, Threat, and Countermeasure scenarios.

TABLE 1
Vulnerability/Threat/Countermeasure Summary

| Asset to Protect | Threat Vectors | Device 114 Countermeasures |
|---|---|---|
| Highly personal | Owned Device | Owned Device |
| information (e.g., texts, | 1. Steal password and | 1. Device 114 adds a second factor |
| video, email) stored on | storage medium; | of authentication (2FA) for access |
| user owned devices or in | 2. Brute force password and | control. |
| a cloud folder. | have remote access to | 2. Device 114 based 2FA precludes |
| | device; | remote access with password |
| | 3. Steal device and physically | only. |
| | access storage medium. | 3. Device 114 has tamper |
| | 4. Eavesdrop over Interface | protection. |
| | connection | 4. Security for data in transit |
| | 5. Spoof the legit application | between a Device 114 and an |
| | with malware. | application (e.g., referred to as an |
| | | Interface application) is based on |
| | | the strongest possible |
| | | cryptographic algorithms, using |
| | | certificates issued by a public key |
| | | infrastructure that has an intuitive |
| | | management interface |
| | | (dashboard). |
| | | 5. Access to information on a |
| | | Device 114 employs a properly |
| | | provisioned application. |
| | | The right PIN can be entered to |
| | | unlock the Device 114. |
| | | If configured to access the Security |
| | | Framework Provider Network |
| | | before unlock, the Device 114 is |
| | | guaranteed to download |
| | | revocation information prior to |
| | | unlocking its contents. If the |
| | | Device 114 is itself revoked (e.g., |
| | | when stolen), it will automatically |
| | | terminate unlock processing and |
| | | erase its contents. |
| | Cloud Storage | Cloud Storage |
| | 1. Steal or brute force | 1. Use Device 114 as |
| | password; | authentication mechanism in |
| | 2. Local physical access to | addition or substitute to |
| | cloud storage. | password. |
| | | 2. User data is encrypted |
| | | removing value to local physical |
| | | access to cloud server. |
| | Either Owned Device or | Either Owned Device or Cloud |
| | Cloud Storage | Storage |
| | 1. Distracted users walk away | 1. Device 114 proximity access |
| | from unlocked devices, | model protects user when the |
| | making data on the device | user device is left behind-the |
| | visible to anyone with | Device 114 is small enough to |
| | physical access. | carry in a shirt pocket or on a |
| | | keychain, and can be |
| | | automatically detected by user |
| | | devices loaded with applications. |
| | | Once the Device 114 leaves the |
| | | immediate area of the user device |
| | | 118, the Device 114 locks itself, |
| | | and the application can be |
| | | configured to erase sensitive data |
| | | in memory. |
| Keys and Credentials to | Owned Device/Cloud Storage | Owned Device/Cloud Storage |
| access encrypted data or | Keys and Credentials are | Keys and credentials are stored |
| login to devices. | stolen from persistent | encrypted and split with a user |
| | memory. | password to prevent unauthorized |
| | | access while the Device 114 is |
| | | locked. |
| Data stored on memory | Attacker intending to cause | Device 114 transfer allows data to |
| devices (e.g., USB drives | denial of service. | be sent in ciphertext (e.g., |
| with crypto engines) is | | encrypted) form to a separate |
| permanently lost if the | | storage medium. If the Device 114 |
| memory device fails or is | | is destroyed, recovery of the data |
| physically attacked/ | | in plaintext form is possible by |
| destroyed. Storing | | downloading the ciphertext into a |
| backups allows recovery, | | new Device 114, and entering a |
| but requires storing | | user-defined Transfer Password |
| sensitive data in | | associated with the transfer data. |
| plaintext (vulnerable) | | |
| form, or instituting a | | |
| second secure storage | | |
| solution. | | |

Advantageously, the Device 114 can be configured in any suitable form, for example, including the device 114 having general forms, such as Fob, Wristband, Ring, Credit card, any suitable object making sense to be carried with a person, and the like. The device 114 can be configured, for example, as an adapter that has a computer chip, and the like, therein. Such a chip can include security keys, security algorithms, secure storage, and the like, and wherein the adapter includes wireless or other type of low range connections and connectivity, and the like. Unlocking such a device can be accomplished via password entry on a host keyboard, or via direct interaction with the device, such as via built in biometric measuring capability such as fingerprint reading, and the like.

Accordingly, Bluetooth, WiFi, SD interface devices, and the like can be employed for or with the device 114. For example, a PAC device can be employed in MicroSD from factor. This device seats into any device that has an SD, MicroSD, and the like slot. In addition, there, are numerous adapters that have MicroSD slots, and which can be employed with the device 114.

Thus, the present invention is not directed to wireless storage, but rather how to enable secure storage that becomes the secure storage of various user devices (e.g., for Phones, Tablets, PC's, Cars, Refrigerators, Thermostats) of one person. In this way, the device 114 can be employed like a digital keyring of a person across that person's Internet of Things (loT). Accordingly, the device 114, for example, configured as a MicroSD card with security keys, security algorithm, secure storage, and the like, can be integrated into various adapters, and the like. Secure storage is understood to apply to both data and software objects. So, for example, the information stored securely on device 114 could be both a banking application as well as data it operates on (e.g., account numbers, balances, etc.); neither the application nor its associated data are accessible until device 114 is unlocked.

The above described devices and subsystems of the illustrative embodiments can include, for example, any suitable servers, workstations, PCs, laptop computers, PDAs, Internet appliances, handheld devices, cellular telephones, wireless devices, computer architectures including x86, ARM, MPIS with operating system (OS) platforms including Windows, Linux, iOS, Android, other electronic devices, and the like, capable of performing the processes of the illustrative embodiments. The devices and subsystems of the illustrative embodiments can communicate with each other using any suitable protocol and can be implemented using one or more programmed computer systems or devices. One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMAX Networks, “cloud” computer networks, virtual machine and hosting networks, a combination thereof, and the like.

It is to be understood that the devices and subsystems of the illustrative embodiments are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present invention. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof. All or a portion of the devices and subsystems of the illustrative embodiments can be conveniently implemented using one or more general purpose computer systems, microprocessors, digital signal processors, micro-controllers, application processors, domain specific processors, application specific signal processors, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present invention for performing all or a portion (e.g., if processing is distributed) of the processing performed in implementing the illustrative embodiments. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, SW frameworks including .NET/CLR, JVM, scripting frameworks including PHP, Python, Perl, Shell, and the like. Moreover, parts of the processing of the illustrative embodiments of the present invention can be distributed for better performance, reliability, cost, and the like.

As stated above, the devices and subsystems of the illustrative embodiments can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, flash memories, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, transmission media including WiFi/802.11, BT, 3G, LTE, and the like. Common forms of computer-readable media can include, for example, a floppy disk, a flexible disk, hard disk, magnetic tape, any other suitable magnetic medium, a CD-ROM, CDRW, DVD, solid-state drive (SSD) storage devices, any other suitable optical medium, punch cards, paper tape, optical mark sheets, any other suitable physical medium with patterns of holes or other optically recognizable indicia, a RAM, a PROM, an EPROM, a FLASH-EPROM, a DRAM, a DDR, a NAND/NOR flash device, any other suitable memory chip or cartridge, a carrier wave, or any other suitable medium from which a computer can read.

While the present invention has been described in connection with a number of illustrative embodiments and implementations, the present invention is not so limited, but rather covers various modifications and equivalent arrangements, which fall within the purview of the appended claims.

What is claimed is:

1. A system for proximity-based access control, the system comprising:
a physical token device having a programmable computing device, a memory storage device, and a wireless radio device having a limited range; and
a user device that couples to the physical token device over one of:
a wireless interface to the wireless radio device integrated into the physical token, and
a physical interface to the physical token with electrical connectivity between the physical token and the user device;
wherein the programmable computing device is configured to only allow the user device to access the memory storage device over the wireless or physical interface when the physical token device is either within the limited range of the wireless radio device, or physically attached such that electrical connection is possible, respectively.

2. The system of claim 1, wherein the physical token device is one of a Fob device, a keyfob device, a wristband device, a ring device, and a credit card device.

3. The system of claim 1, wherein the user device is one of an Android device, an iPhone device, a tablet device, a smartphone device, a workstation, a PC, a laptop, or generally any device or adapter which provides a frame or sleeve for physical including mechanical or electro-permanent magnetic capture of the physical token device.

4. The system of claim 1, wherein the wireless radio device is one of a Bluetooth radio device, a Wi-Fi radio device, and a Near Field Communication (NFC) radio device, and the wireless interface is one of a Bluetooth wireless interface, a Wi-Fi wireless interface, and an NFC wireless interface.

5. The system of claim 1, wherein the physical token device includes a token interface application configured to interface the physical token device over a cloud-based network with a Security Framework Provider (SFP).

6. The system of claim 5, wherein the physical token device includes a USB port, or other physical connection providing electrical connectivity, for charging the physical token device from the user device, and providing a secure connection to the Security Framework Provider (SFP) over the cloud-based network via the user device coupled to the physical token device via the USB port, as well as a secure connection for sensitive operations, including keying, and provisioning operations.

7. A method for proximity-based access control, the method comprising the steps from at least any one of system claims 1-6.

8. A tangible, non-transitory computer readable medium for proximity-based access control, and comprising one or more computer readable instructions configured to cause one or more computer processors to perform the steps from at least any one of system claims 1-6.
